(19) United States
(12) Patent Application Publication
(10) Pub. No.: US 2009/0244136 A1
(43) Pub. Date: Oct. 1, 2009

(54) Drawing method, inkjet head, drawing apparatus, method for fabricating printed wiring board and method for manufacturing color filter

(75) Inventor: Hiroshi Mataki, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/382,732

(22) Filed: Mar. 23, 2009

(30) Foreign Application Priority Data
Mar. 27, 2008 (JP) 2008-084818

(51) Int. Cl. B41J 29/38; B41J 2/15; B21D 53/76

(52) U.S. Cl. 347/12; 347/41; 29/890.1

(57) ABSTRACT

A drawing method includes three or more liquid drops are discharged by an inkjet method so as to draw a pattern on a substrate. The plural liquid drops are grouped into a plurality of groups that include at least a group composed of two or more adjacent liquid drops and each of which is composed of one, or two or more liquid drops. In each group composed of two or more liquid drops, each liquid drop hits the substrate so as to overlap an adjacent liquid drop of the same group. Also, a liquid drop disposed at an end of one group hits the substrate to be spaced from an adjacent liquid drop disposed at an end of an adjacent group to be joined to the adjacent liquid drop of the adjacent group when spread on the substrate.

The present invention claims priority from Japanese Patent Application No. 2008-084818 filed on Mar. 27, 2008, the entire content of which is incorporated herein by reference.

### BACKGROUND OF INVENTION

1. Field of the Invention

The present invention relates to a drawing method, an inkjet head, a drawing apparatus, a method for manufacturing a printed wiring board and a method for manufacturing a color filter.

2. Description of the Related Art

As a method for forming a wiring pattern on a printed wiring board or forming RGB pixels of a color filter used in a liquid crystal display or the like, a method in which a liquid including a functional material (such as a conductive ink or a color resist ink) is discharged onto a substrate by an inkjet method is known (see, for example JP-A-2003-317945 and JP-A-2003-266669).

In a technique disclosed in JP-A-2003-266669, a plurality of liquid drops are discharged at a prescribed pitch, so as to form a linear pattern extending along a prescribed direction. The adjacent liquid drops are allowed to hit on a substrate to be spaced from each other, so as to be joined to each other when spread on the substrate. Thus, a liquid drop hit later is prevented from overlapping and being absorbed by a liquid drop hit ahead, and hence, each liquid drop may be isotropically spread so as to easily control the width of a pattern to be formed.

In the technique disclosed in JP-A-2003-266669, all liquid drops are allowed to hit on the substrate without overlapping adjacent liquid drops so as to be joined to the adjacent liquid drops when spread. Therefore, a distance between the adjacent liquid drops tends to be large, and it is apprehended that jaggy, that is, irregularities with a cycle of one drop, may be caused. On the other hand, when the distance between the adjacent liquid drops is reduced and all liquid drops are allowed to hit on a substrate so as to overlap adjacent liquid drops, a liquid drop hit later overlaps and is absorbed by a liquid drop hit ahead. As a result, it is apprehended that the liquid may be collected on a specific portion so as to form a bulge.

### SUMMARY OF INVENTION

The present invention is devised in consideration of the aforementioned circumstances, and an object of the present invention is providing a drawing method, an inkjet head and a drawing apparatus in which a pattern with a uniform width may be drawn on a target material with occurrence of the jaggy and the bulge suppressed, and providing a method for manufacturing a high quality printed wiring board and a method for manufacturing a high quality color filter.

The aforementioned object is achieved by the following drawing methods of the present invention.

(1) A method for drawing a pattern extending in a direction on a target material by discharging three or more liquid drops by an inkjet method may include grouping the three or more liquid drops into a plurality of groups which include at least a group composed of two or more adjacent liquid drops and each of which is composed of one, or two or more liquid drops, discharging each liquid drop included in the group composed of two or more liquid drops so that the adjacent liquid drop hit the target material to overlap each other; and discharging a liquid drop at an end of each group so that the liquid drop hit the target material to be spaced from an adjacent liquid drop at an end of an adjacent group and the liquid drop is spread on the adjacent liquid drop disposed at the end of the adjacent group.

(2) The plurality of liquid drops may hit the target material successively along the pattern with one end of the pattern as a starting point.

(3) A method for drawing a pattern extending in a direction on a target material by discharging three or more liquid drops by an inkjet method may include discharging the plurality of liquid drops to successively hit the target material along the pattern with one end of the pattern as a starting point, wherein, when n is an odd number or an even number, an (n+1)th liquid drop hits the target material to overlap an area where an nth liquid drop has been hit and spread on the target material , an (n+2)th liquid drop hits the target material not to overlap an area where the (n+1)th liquid drop has been hit and spread on the target material so that the (n+1)th liquid drop and the (n+2)th liquid drop spread and overlap each other.

(4) A time elapsing between a hit of the nth liquid drop and a hit of the (n+1)th liquid drop may be longer than a time elapsing between the hit of the (n+1)th liquid drop and a hit of the (n+2)th liquid drop.

(5) A first pitch between a center of the nth liquid drop and a center of the (n+1)th liquid drop may be less than a diameter of each liquid drop obtained before hit.

(6) The following equation (i) may be satisfied:

$$\frac{D}{2 {\{ 8 tan \frac{θ}{2} ( 3 + {tan}^{2} \frac{θ}{2} ) \}}^{\frac{1}{3}}} + \frac{D}{2} < p 2 < \frac{D}{2 {\{ 8 tan \frac{θ}{2} ( 3 + {tan}^{2} \frac{θ}{2} ) \}}^{\frac{1}{3}}}$$

wherein p2 represents a second pitch between the (n+1)th liquid drop and the (n+2)th liquid drop, D represents a diameter of each liquid drop obtained before hit, and θ represents a contact angle between the target material and each liquid drop.

$$\frac{D}{2 {\{ 8 tan \frac{θ}{2} ( 3 + {tan}^{2} \frac{θ}{2} ) \}}^{\frac{1}{3}}} + \frac{D}{2} < p 2 < \frac{D}{2 {\{ 8 tan \frac{θ}{2} ( 3 + {tan}^{2} \frac{θ}{2} ) \}}^{\frac{1}{3}}} \qquad ( i )$$

In the drawing method of (1) described above, since the liquid drops are grouped into groups at least including a group composed of two or more adjacent drops, and respective liquid drops of a group composed of two or more liquid drops are allowed to hit to overlap each other, the occurrence of jaggy may be suppressed. Even when a bulge is formed in a group composed of two or more liquid drops, since a liquid drop disposed at an end of the group is spread to be joined to an adjacent liquid drop disposed at an end of an adjacent group, a liquid is made to flow from the bulge to a joining portion. Therefore, a pattern with a uniform width may be drawn.

In the drawing method of (2) described above, a pattern may be drawn through one scanning.

In the drawing method of (3) described above, a plurality of liquid drops may be grouped into groups each composed of two drops, so that the liquid quantity of each group may be reduced for suppressing the occurrence of a bulge. Furthermore, since respective liquid drops of each group composed of two liquid drops are allowed to hit to overlap each other, the occurrence of jaggy may be suppressed. Moreover, even when a bulge is formed in a group composed of two liquid drops, since a liquid drop disposed at an end of the group is spread to be joined to an adjacent liquid drop disposed at an end of an adjacent group, a liquid is made to flow from the bulge to a joining portion. Therefore, a pattern with a uniform width may be drawn.

In the drawing method of (4) described above, the discharging frequency is controlled so that the (n+1)th liquid drop may be allowed to hit so as to overlap the area where the nth liquid drop has been spread on the target material after the hit, that the (n+2)th liquid drop may be allowed to hit so as not to overlap the area where the (n+1)th liquid drop has been spread on the target material after the hit, and that the (n+1)th liquid drop and the (n+2)th liquid drop may be allowed to be joined to each other when spread on the target material. This method is suitably used when a dot pitch is desired to be constant.

In the drawing method of (5) described above, the dot pitch may be controlled so that the (n+1)th liquid drop may be allowed to hit so as to overlap the area where the nth liquid drop has been spread on the target material after the hit. This method is suitably used when the discharging frequency is desired to be constant.

In the drawing method of (6) described above, the dot pitch may be controlled so that the (n+2)th liquid drop may be allowed to hit so as not to overlap the area where the (n+1)th liquid drop has been spread on the target material after the hit and that the (n+1)th liquid drop and the (n+2)th liquid drop may be allowed to be joined to each other when spread on the target material. This method is suitably used when the discharging frequency is desired to be constant.

Moreover, the aforementioned object is achieved by the following inkjet heads of the present invention:

(7) An inkjet head may include three or more nozzles arranged in a direction so that each of the three or more nozzles discharging a liquid drop to draw a pattern extending, wherein the plurality of nozzles are grouped into a plurality of groups that include at least a group composed of two or more adjacent nozzles and each of which is composed of one, or two or more nozzles, two nozzles adjacent to each other in the group including two or more adjacent nozzle have such a pitch that liquid drops discharged from the two nozzles hit the target material to overlap each other, and a nozzle disposed at an end of one group and an adjacent nozzle disposed at an end of an adjacent group have such a pitch that liquid drops discharged from the adjacent nozzles hit the target material to be spaced from each other so as to spread and overlap each other.

(8) An inkjet head may include three or more nozzles which are arranged in a direction for drawing of discharging a pattern extending in a direction on a target material by discharging a liquid drop from each nozzle, wherein, when one end of arrangement of the plurality of nozzles is a starting point and n is an odd number or an even number, a first pitch between a center of an nth nozzle and a center of an (n+1)th nozzle is a pitch for discharging a liquid drop discharged from the (n+1)th nozzle to hit the target material to overlap an area where a liquid drop discharged from the nth nozzle has been hit and spread on the target material, and a second pitch between a center of the (n+1)th nozzle and a center of an (n+2)th nozzle is a pitch for discharging a liquid drop discharged from the (n+2)th nozzle to hit the target material not to overlap an area where the liquid drop discharged from the (n+1)th nozzle has been hit and spread on the target material so that the liquid drop discharged from the (n+1)th nozzle and the liquid drop discharged from the (n+2)th nozzle are spread and overlapped each other.

(9) The first pitch may be less than a diameter of each liquid drop obtained before hit.

(10) The following equation (ii) may be satisfied,

$$\frac{D}{2 {\{ 8 tan \frac{θ}{2} ( 3 + {tan}^{2} \frac{θ}{2} ) \}}^{\frac{1}{3}}} + \frac{D}{2} < p 2 < \frac{D}{2 {\{ 8 tan \frac{θ}{2} ( 3 + {tan}^{2} \frac{θ}{2} ) \}}^{\frac{1}{3}}}$$

wherein p2 represents a second pitch between the (n+1)th liquid drop and the (n+2)th liquid drop, D represents a diameter of each liquid drop obtained before hit, and θ represents a contact angle between the target material and each liquid drop.

$$\frac{D}{2 {\{ 8 tan \frac{θ}{2} ( 3 + {tan}^{2} \frac{θ}{2} ) \}}^{\frac{1}{3}}} + \frac{D}{2} < p 2 < \frac{D}{2 {\{ 8 tan \frac{θ}{2} ( 3 + {tan}^{2} \frac{θ}{2} ) \}}^{\frac{1}{3}}} \qquad ( ii )$$

In the inkjet head of (7) described above, a plurality of liquid drops discharged from the respective nozzles may be grouped into a plurality of groups that include at least a group composed of two or more adjacent liquid drops and each of which is composed of one, two or more liquid drops. Since respective liquid drops of a group composed of two or more liquid drops are allowed to hit to overlap each other, the occurrence of jaggy may be suppressed. Furthermore, even when a bulge is formed in a group composed of two or more liquid drops, since a liquid drop disposed at an end of the group is spread to be joined to an adjacent liquid drop disposed at an end of an adjacent group, a liquid is made to flow from the bulge to a joining portion. Therefore, a pattern with a uniform width may be drawn.

In the inkjet head of (8) described above, a plurality of liquid drops discharged from the respective nozzles may be grouped into groups each composed of two drops, so that the liquid quantity of each group may be reduced for suppressing the occurrence of a bulge. Furthermore, since respective liquid drops of each group composed of two liquid drops are allowed to hit to overlap each other, the occurrence of jaggy may be suppressed. Moreover, even when a bulge is formed in a group composed of two drops, since a liquid drop disposed at an end of the group is spread to be joined to an adjacent liquid drop disposed at an end of an adjacent group, a liquid is made to flow from the bulge to a joining portion. Therefore, a pattern with a uniform width may be drawn.

In the inkjet head of (9) described above, the pitch of the nozzles is controlled so that a liquid drop discharged from the (n+1)th nozzle may be allowed to hit so as to overlap an area where a liquid drop discharged from the nth nozzle has been spread on the target material after hit.

In the inkjet head of (10) described above, the pitch of the nozzles is controlled so that a liquid drop discharged from the (n+2)th nozzle may be allowed to hit so as not to overlap an area where a liquid drop discharged from the (n+1)th nozzle has been spread on the target material after hit and that the liquid drop discharged from the (n+1)th nozzle and the liquid drop discharged from the (n+2)th nozzle may be allowed to be joined to each other when spread on the target material.

Moreover, the aforementioned object is achieved by the following drawing apparatuses of the present invention.

(11) A drawing apparatus for drawing a pattern extending in a direction on a target material by discharging three or more liquid drops by an inkjet method may include an inkjet head which is discharges the plurality of liquid drops; and a moving mechanism which moves the inkjet head relatively to the target material in the direction, wherein three or more liquid drops are grouped into a plurality of groups that include at least a group composed of two or more adjacent liquid drops and each of which is composed of one, or two or more liquid drops, and each liquid drop included in a group composed of two or more liquid drops is discharged to hit the target material to overlap an adjacent liquid drop of the same group, and a liquid drop at an end of one group hits the target material to be spaced from an adjacent liquid drop at an end of an adjacent group so that the liquid drop at an end of one group is spread and overlapped the adjacent liquid drop at the end of the adjacent group when spread on the target material.

(12) The inkjet head may be relatively moved while discharging the plurality of liquid drops along the pattern with one end of the pattern set as a starting point.

(13) A drawing apparatus for drawing a pattern extending in a direction on a target material by discharging three or more liquid drops by an inkjet method may include an inkjet head which discharges the plurality of liquid drops; and a moving mechanism which moves the inkjet head relatively to the target material in the direction, wherein the inkjet heat is relatively moved while successively discharging the plurality of liquid drops along the pattern with one end of the pattern set as a starting point, and when n is an odd number or an even number, an (n+1)th liquid drop hits the target material to overlap an area where an nth liquid drop has been hit and spread on the target material, an (n+2)th liquid drop hits the target material not to overlap an area where the (n+1)th liquid drop has been hit and spread on the target material so that the (n+1)th liquid drop and the (n+2)th liquid drop are spread and overlapped each other when spread on the target material.

(14) A time elapsing between a discharge of the nth liquid drop and a discharge of the (n+1)th liquid drop may be longer than a time elapsing between the discharge of the (n+1)th liquid drop and a discharge of the (n+2)th liquid drop.

(15) The moving mechanism may relatively move the inkjet head that a first pitch between the nth liquid drop and the (n+1)th liquid drop is less than a diameter of each liquid drop obtained before hit.

(16) The moving mechanism may relatively move the inkjet head, and the following equation (i) is satisfied,

$$\frac{D}{2 {\{ 8 tan \frac{θ}{2} ( 3 + {tan}^{2} \frac{θ}{2} ) \}}^{\frac{1}{3}}} + \frac{D}{2} < p 2 < \frac{D}{2 {\{ 8 tan \frac{θ}{2} ( 3 + {tan}^{2} \frac{θ}{2} ) \}}^{\frac{1}{3}}}$$

wherein p2 represents a second pitch between the (n+1)th liquid drop and the (n+2)th liquid drop, D represents a diameter of each liquid drop obtained before hit, and θ represents a contact angle between the target material and each liquid drop.

$$\frac{D}{2 {\{ 8 tan \frac{θ}{2} ( 3 + {tan}^{2} \frac{θ}{2} ) \}}^{\frac{1}{3}}} + \frac{D}{2} < p 2 < \frac{D}{2 {\{ 8 tan \frac{θ}{2} ( 3 + {tan}^{2} \frac{θ}{2} ) \}}^{\frac{1}{3}}} \qquad ( i )$$

(17) A drawing apparatus may includes an inkjet head.

In the drawing apparatus of (11) described above, since the liquid drops are grouped into groups at least including a group composed of two or more adjacent drops, and respective liquid drops of one group composed of two or more liquid drops are allowed to hit to overlap each other, the occurrence of jaggy may be suppressed. Even when a bulge is formed in a group composed of two or more liquid drops, since a liquid drop disposed at an end of the group is spread to be joined to an adjacent liquid drop disposed at an end of an adjacent group, a liquid is made to flow from the bulge to a joining portion. Therefore, a pattern with a uniform width may be drawn.

In the drawing apparatus of (12) described above, a pattern may be drawn through one scanning.

In the drawing apparatus of (13) described above, a plurality of liquid drops may be grouped into groups each composed of two drops, so that the liquid quantity of each group may be reduced for suppressing the occurrence of a bulge. Furthermore, since respective liquid drops of each group composed of two liquid drops are allowed to hit to overlap each other, the occurrence of jaggy may be suppressed. Moreover, even when a bulge is formed in a group composed of two drops, since a liquid drop disposed at an end of the group is spread to be joined to an adjacent liquid drop disposed at an end of an adjacent group, a liquid is made to flow from the bulge to a joining portion. Therefore, a pattern with a uniform width may be drawn.

In the drawing apparatus of (14) described above, the discharging frequency is controlled so that the (n+1)th liquid drop may be allowed to hit so as to overlap the area where the nth liquid drop has been spread on the target material after hit, that the (n+2)th liquid drop may be allowed to hit so as not to overlap the area where the (n+1)th liquid drop has been spread on the target material after hit, and that the (n+1)th liquid drop and the (n+2)th liquid drop may be allowed to be joined to each other when spread on the target material. This apparatus is suitably used when a dot pitch is desired to be constant.

In the drawing apparatus of (15) described above, the dot pitch may be controlled so that the (n+1)th liquid drop may be allowed to hit so as to overlap the area where the nth liquid drop has been spread on the target material after the hit. This apparatus is suitably used when the discharging frequency is desired to be constant.

In the drawing apparatus of (16) described above, the dot pitch may be controlled so that the (n+2)th liquid drop may be allowed to hit so as not to overlap the area where the (n+1)th liquid drop has been spread on the target material after the hit and that the (n+1)th liquid drop and the (n+2)th liquid drop may be allowed to be joined to each other when spread on the target material. This apparatus is suitably used when the discharging frequency is desired to be constant.

In the drawing apparatus of (17) described above, the same effects as those attained by the inkjet heads of (7) through (10) may be attained.

Moreover, the aforementioned object is achieved by the following method for manufacturing a printed wiring board of the present invention.

(18) A drawing apparatus may include an inkjet head.

In the method for manufacturing a printed wiring board of (18) described above, the wiring pattern attains a uniform pattern width. As a result, the quality of the printed wiring board may be improved.

Moreover, the aforementioned object is achieved by the following method for manufacturing a color filter of the present invention.

(19) A method for manufacturing a color filter on which a plurality of pixels and a black matrix partitioning the plurality of pixels are provided may include drawing at least one of the plurality of pixels and the black matrix by a method for drawing.

In the method for manufacturing a color filter of (19) described above, the pixels and/or black matrix may attain a uniform pattern width. As a result, the quality of the color filter may be improved.

The present invention provides a drawing method, an inkjet head and a drawing apparatus in which a pattern with a uniform width may be drawn on a target material with the occurrence of jaggy and bulge suppressed. Furthermore, the present invention provides a method for manufacturing a high quality printed wiring board and a method for manufacturing a high quality color filter.

### BRIEF DESCRIPTION OF THE DRAWINGS

FIG. 1 is a front view showing the architecture of a drawing apparatus according to exemplary embodiment 1;

FIG. 2 is a perspective view showing the architecture of the drawing apparatus according to exemplary embodiment 1;

FIG. 3A is a diagram explaining a drawing method according to exemplary embodiment 1;

FIG. 3B is a diagram explaining a drawing method according to exemplary embodiment 1;

FIG. 3C is a diagram explaining a drawing method according to exemplary embodiment 1;

FIG. 4A is a diagram explaining the drawing method according to exemplary embodiment 1;

FIG. 4B is a diagram explaining the drawing method according to exemplary embodiment 1;

FIG. 4C is a diagram explaining the drawing method according to exemplary embodiment 1;

FIG. 5 is a perspective view showing the architecture of a drawing apparatus according to exemplary embodiment 2;

FIG. 6A is a diagram explaining a drawing method according to exemplary embodiment 2; and

FIG. 6B is a diagram explaining a drawing method according to exemplary embodiment 2.

### DESCRIPTION OF EXEMPLARY EMBODIMENTS

Now, preferred embodiments of a drawing method, an inkjet head and a drawing apparatus of the present invention will be described with reference to the accompanying drawings.

### Exemplary Embodiment 1

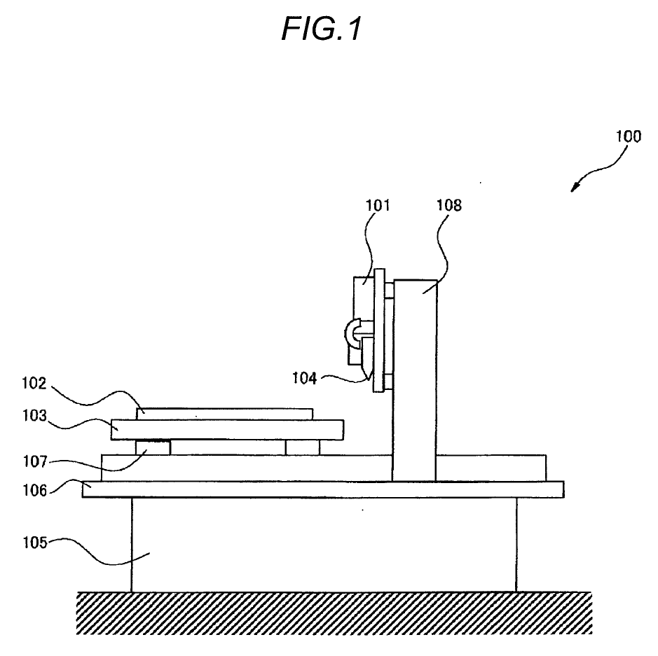

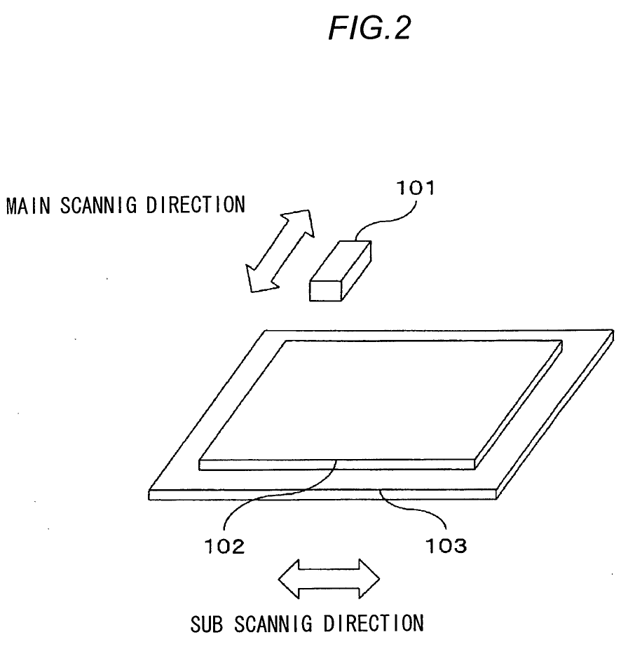

A drawing apparatus according to exemplary embodiment 1 will be described with reference to FIGS. 1 and 2.

The drawing apparatus 100 includes, as shown in FIGS. 1 and 2, an inkjet head 101 that discharges a plurality of liquid drops and a supporting table 103 that holds a substrate 102, that is, a target material on which a prescribed pattern is to be drawn with the liquid drops discharged from the inkjet head 101.

The material for the substrate 102 is appropriately selected in accordance with the use. With respect to a printed wiring board, for example, an organic film of polyimide or the like may be used when the desired wiring board is flexible, and base paper impregnated with phenol or epoxy, or ceramics may be used when it is rigid. Alternatively, glass or the like may be used for a color filter of a liquid crystal display.

The inkjet head 101 and the supporting table 103 are provided above a surface plate 106 placed on a vibration isolating table 105 installed on a floor. A table moving mechanism 107 and a head moving mechanism 108 are provided on the surface plate 106, so that the supporting table 103 may be held by the table moving mechanism 107 and that the inkjet head 101 may be held by the head moving mechanism 108.

The table moving mechanism 107 and the head moving mechanism 108 together move the inkjet head 101 relatively to the substrate 102 held by the supporting table 103 along a main scanning direction and a sub scanning direction. For example, the head moving mechanism 108 moves the inkjet head 101 in the main scanning direction along a first axis out of two horizontal orthogonal axes, and the table moving mechanism 107 moves the supporting table 103 and the substrate 102 in the sub scanning direction along a second axis out of the two horizontal orthogonal axes.

The inkjet head 101 is provided with at least one nozzle 104 for intermittently discharging a given amount of solution in the form of a liquid drop. In this embodiment, the nozzle 104 may be plural in number arranged in the main scanning direction and the sub scanning direction.

The solution discharged from the nozzle 104 of the inkjet head 101 as liquid drops is appropriately selected in accordance with the use. For example, for manufacturing a printed wiring board, a conductive ink in which metal fine particles of silver or the like are dispersed may be used. Alternatively, for manufacturing a color filter, a color resist ink in which a coloring agent such as a pigment is dispersed may be used.

In the drawing apparatus 100 having the aforementioned architecture, the inkjet head 101 is moved in the main scanning direction relatively to the substrate 102 while discharging liquid drops from the nozzle 104, so as to plot along a prescribed scanning line of the substrate 102. Subsequently, the inkjet head 101 is relatively moved in the sub scanning direction, so as to similarly plot along a scanning line adjacent to the prescribed scanning line. Thus, a predetermined pattern extending along the main scanning direction is drawn in the respective scanning lines of the substrate 102. When such patterns are combined, a wiring pattern of a printed wiring board and a plurality of RGB pixels and/or a black matrix partitioning the respective pixels of a color filter may be obtained.

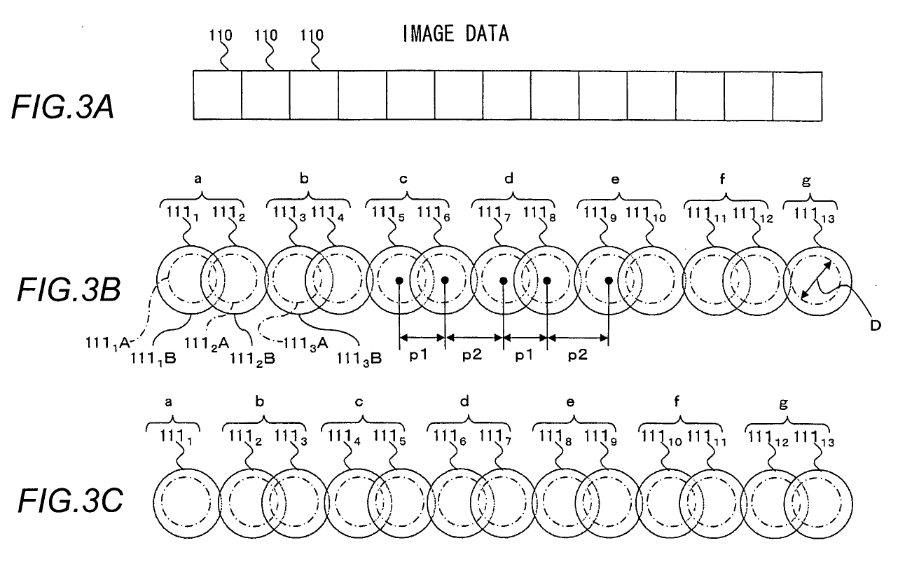

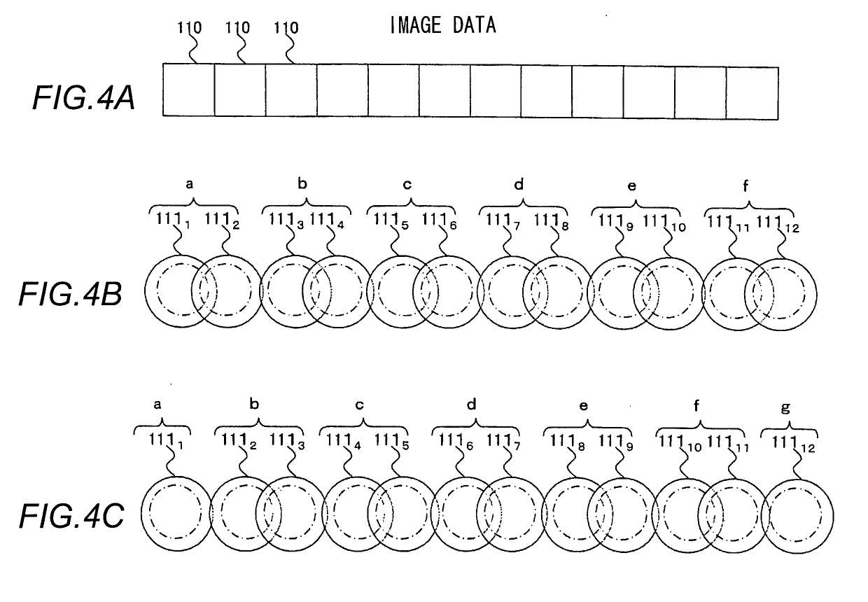

Next, a drawing method for a pattern in respective scanning lines of the substrate 102 will be described with reference to FIGS. 3 and 4. In a case shown in FIG. 3, on the basis of linear image data including dots 110 in an odd number of three or more, a linear pattern extending in the main scanning direction is drawn by using liquid drops 111 in the same number as the dots 110 along prescribed scanning lines of the substrate 102. Also, in a case shown in FIG. 4, on the basis of linear image data including dots 110 in an even number of four or more, a linear pattern extending in the main scanning direction is drawn by using liquid drops 111 in the same number as the dots 110 along prescribed scanning lines of the substrate 102.

In the drawing method of this embodiment, the respective dots 110 of the image data are grouped into a plurality of groups that include at least a group composed of two or more adjacent dots and each of which is composed of one, two or more dots. In other words, since there is one-to-one correspondence between the dots 110 and the liquid drops 111, the plural liquid drops 111 are grouped into a plurality of groups that include at least a group composed of two or more adjacent liquid drops and each of which is composed of one, two or more liquid drops.

Each of FIGS. 3 and 4 shows the case where the plural liquid drops 111 are grouped into a plurality of groups each composed of one or two drops. As shown in each of FIGS. 3B and 4B, assuming that one end (that is, the left end in the drawing) of the pattern is a starting point and that n is an odd number, a liquid drop 111ₙ and a liquid drop 111ₙ₊₁ disposed in the nth and the (n+1)th positions along the pattern together make up one group, and a liquid drop 111ₙ₊₂ disposed in the (n+2)th position is grouped into a different group from the (n+1)th liquid drop 111ₙ₊₁. Specifically, in the case shown in FIG. 3B, a first liquid drop 111₁ and a second liquid drop 111₂ together make up a group a, and a third liquid drop 111₃ and a fourth liquid drop 111₄ together make up a group b. Liquid drops disposed thereafter are similarly grouped so as to make up groups c through f by two adjacent liquid drops each. The final 13th liquid drop 111₁₃ singly makes up a group g. On the other hand, in the case shown in FIG. 4B, since the number of the liquid drops 111 is even, each of all the groups a through f is composed of two drops.

In each of the cases shown in FIGS. 3C and 4C, assuming that one end (that is, the left end in the drawing) of the pattern is a starting point and that n is an even number (including zero), a liquid drop 111ₙ and a liquid drop 111ₙ₊₁ disposed in the nth and the (n+1)th positions along the pattern together make up one group, and a liquid drop 111ₙ₊₂ disposed in the (n+2)th position is grouped into a different group from the (n+1)th liquid drop 111ₙ₊₁. Specifically, in the case shown in FIG. 3C, a first liquid drop 111₁ singly makes up a group a. Liquid drops disposed thereafter are grouped so as to make up groups b through f by two adjacent liquid drops each. On the other hand, in the case shown in FIG. 4C, since the number of the liquid drops 111 is even and a first liquid drop 111₁ singly makes up a group a, the final 12th liquid drop 111₁₂ also singly makes up a group g.

In the drawing method of this embodiment, in each group composed of two or more liquid drops, each liquid drop 111 is allowed to hit on the substrate 102 so as to overlap an adjacent liquid drop of the same group. In the case shown in each of FIGS. 3B and 4B, for example, the liquid drops 111₁ and 111₂ of the group a are allowed to hit to overlap each other, and assuming that n is an odd number, the nth liquid drop 111ₙ and the (n+1)th liquid drop 111ₙ₊₁ are allowed to hit to overlap each other. In the case shown in each of FIGS. 3C and 4C, for example, the liquid drops 111₂ and 111₃ of the group b are allowed to hit to overlap each other, and assuming that n is an even number, the nth liquid drop 111ₙ and the (n+1)th liquid drop 111ₙ₊₁ are allowed to hit to overlap each other.

Herein, adjacent liquid drops 111 being allowed to hit to overlap each other means the following: For example, in the case shown FIG. 3B, assuming that the liquid drop 111₁ is allowed to hit on the substrate 102 prior to the liquid drop 111₂, the liquid drop 111₂ is allowed to hit so that an area 111₁B obtained when the liquid drop 111₁ is spread on the substrate 102 at least partly overlaps an area 111₂A obtained by orthogonally projecting the liquid drop 111₂ onto the substrate 102. In FIG. 3B, areas 111₁A, 111₂A and 111₃A shown with alternate long and short dash lines respectively correspond to areas obtained by orthogonally projecting, onto the substrate 102, the liquid drops 111₁, 111₂ and 111₃ before the hit, and the diameter of each of these areas is identical to the diameter D of each liquid drop obtained before the hit. Also, areas 111₁B, 111₂B and 111₃B shown with solid lines respectively correspond to areas obtained when the liquid drops 111₁, 111₂ and 111₃ are spread on the substrate 102.

Furthermore, in the drawing method of this embodiment, a liquid drop 111 disposed at an end of one group is allowed to hit on the substrate 102 to be spaced from an adjacent liquid drop 111 disposed at an end of an adjacent group, so as to be joined to the adjacent liquid drop 111 of the adjacent group when spread on the substrate 102. In the case shown in each of FIGS. 3B and 4B, for example, the liquid drop 111₂ of the group a and the liquid drop 111₃ of the group b are allowed to hit to be spaced from each other, and assuming that n is an odd number, the (n+1)th liquid drop 111ₙ₊₁ and the (n+2)th liquid drop 111ₙ₊₂ are allowed to hit to be spaced from each other. Moreover, in the case shown in each of FIGS. 3C and 4C, for example, the liquid drop 111₁ of the group a and the liquid drop 111₂ of the group b are allowed to hit to be spaced from each other, and assuming that n is an even number, the (n+1)th liquid drop 111ₙ₊₁ and the (n+2)th liquid drop 111ₙ₊₂ are allowed to hit to be spaced from each other.

At this point, being allowed to hit to be spaced from an adjacent liquid drop 11 means the following: For example, in the case shown in FIG. 3B, assuming that the liquid drop 111₂ is allowed to hit on the substrate 102 prior to the liquid drop 111₃, the liquid drop 111₃ is allowed to hit so that an area 111₂B obtained when the liquid drop 111₂ is spread on the substrate 102 may not overlap an area 111₃A obtained by orthogonally projecting the liquid drop 111₃ onto the substrate 102. Also, being joined when spread on the substrate means that the area 111₂B obtained when the liquid drop 111₂ is spread on the substrate 102 at least partly overlaps the area 111₃B obtained when the liquid drop 111₃ is spread on the substrate 102.

In the aforementioned drawing method, the respective liquid drops 111 of each group composed of two or more drops are allowed to hit to overlap each other and become continuous to each other after the hit. Furthermore, a liquid drop 111 disposed at an end of one group is spread after the hit to be joined to an adjacent liquid drop 111 disposed at an end of an adjacent group. Accordingly, all the liquid drops 111 become continuous to one another, so that a prescribed pattern extending in the main scanning direction may be drawn along the respective scanning lines of the substrate 102.

Since the respective liquid drops 111 of each group composed of two or more drops are allowed to hit to overlap each other, a distance between the adjacent liquid drops 111 is never too large, and therefore, the occurrence of jaggy may be suppressed. Therefore, a group composed of merely one drop may avoid. However, the first drop and the final drop comparatively minimally affect the occurrence of jaggy, and therefore, the first drop and the final drop may singly make up a group.

A liquid drop 111 disposed at an end of one group is spread after the hit to be joined to an adjacent liquid drop 111 disposed at an end of an adjacent group. Therefore, even when a bulge is formed in a group composed of two or more drops, the solution flows from the bulge to a joining portion between the groups, resulting in reducing or eliminating the bulge. At this point, the number of liquid drops belonging to a group composed of two or more drops may be smaller and is more preferably two. Thus, the amount of solution contained in each group composed of two or more drops may be reduced, so as to suppress the occurrence of a bulge.

As described so far, according to the drawing method and the drawing apparatus 100 of this embodiment, the occurrence of jaggy and bulge is suppressed, resulting in drawing a pattern with a uniform width. As a result, a wiring pattern with a uniform pattern width may be formed on a printed wiring board, and pixels and/or a black matrix with a uniform pattern width may be formed on a color filter, and thus, the quality of the wiring board and the color filter may be improved.

In the drawing method, the hitting order of the liquid drops 111 is not limited to but may be the arranging order along the pattern. Thus, a pattern may be drawn along each scanning line of the substrate 102 through one scanning without reciprocating the inkjet head 101.

A pitch p1 between two liquid drops 111 adjacent to each other in one group may not be more than the diameter D of each liquid drop 111 obtained before the hit. For example, in the case shown in FIG. 3B, a pitch between the liquid drops 111₅ and 111₆ of the group c or a pitch between the liquid drops 111₇ and 111₈ of the group d, namely, a pitch p1 between the nth liquid drop 111ₙ and the (n+1)th liquid drop 111ₙ₊₁, whereas n is assumed to be an odd number, may not be more than the diameter D of each liquid drop 111 obtained before the hit. Thus, a liquid drop 111 may definitely overlap a priorly hit liquid drop 111 even before the priorly hit liquid drop 111 is spread on the substrate 102.

Furthermore, a pitch p2 between a liquid drop 111 disposed at an end of one group and an adjacent liquid drop 111 disposed at an end of an adjacent group may satisfy an equation (i) described below, wherein the diameter of each liquid drop 111 obtained before the hit is D and a contact angle between the substrate 102 and the liquid drop 111 is θ. For example, in the case shown in FIG. 3B, a pitch between the liquid drop 111₆ of the group c and the liquid drop 111₇ of the group d or a pitch between the liquid drop 111₈ of the group d and the liquid drop 111₉ of the group e, namely, a pitch p2 between the (n+1)th liquid drop 111ₙ₊₁ and the (n+2)th liquid drop 111ₙ₊₂, whereas n is an odd number, may satisfy the following equation (i):

$$\frac{D}{2 {\{ 8 tan \frac{θ}{2} ( 3 + {tan}^{2} \frac{θ}{2} ) \}}^{\frac{1}{3}}} + \frac{D}{2} < p 2 < \frac{D}{2 {\{ 8 tan \frac{θ}{2} ( 3 + {tan}^{2} \frac{θ}{2} ) \}}^{\frac{1}{3}}} \qquad ( i )$$

Thus, no matter whether a priorly hit liquid drop 111 is spread on the substrate 102, a liquid drop 111 may be allowed to hit to be spaced from the priorly hit liquid drop 111 and may be spread after the hit so as to be joined to the priorly hit liquid drop 111. It is noted that D/{8·tan(θ/2)·(3+tan²(θ/2))}^{1/3} corresponds to a diameter 111B of an area obtained when each liquid drop 111 having a diameter D before the hit is spread to the limit on the substrate 102.

When the pitches p1 and p2 between the liquid drops 111 are set in the aforementioned manner, the discharging frequency of the liquid drops 111 may be made constant. The pitch of the liquid drops 111 is controlled by adjusting the relative movement of the inkjet head 101 in the main scanning direction caused by the table moving mechanism 107 and the head moving mechanism 108.

In the case where, for example, the pitch of the liquid drops 111 is fixed, assuming that a plurality of liquid drops 111 are successively hit along a pattern, time elapsing between hit of a first liquid drop 111 and hit of a second liquid drop 111 adjacent to each other in one group is set to be longer than time elapsing between hit of a liquid drop 111 disposed at an end of one group and hit of an adjacent liquid drop 111 disposed at an end of an adjacent group. For example, in the case shown in FIG. 3B, time elapsing between hit of the liquid drop 111₁ and hit of the liquid drop 111₂ of the same group a is set to be longer than time elapsing between hit of the liquid drop 111₂ of the group a and hit of the liquid drop 111₃ of the group b. In other words, assuming that n is an odd number, time elapsing between hit of the nth liquid drop 111ₙ and hit of the (n+1)th liquid drop 111ₙ₊₁ is set to be longer than time elapsing between hit of the (n+1)th liquid drop 111ₙ₊₁ and hit of the (n+2)th liquid drop 111ₙ₊₂.

### Exemplary Embodiment 2

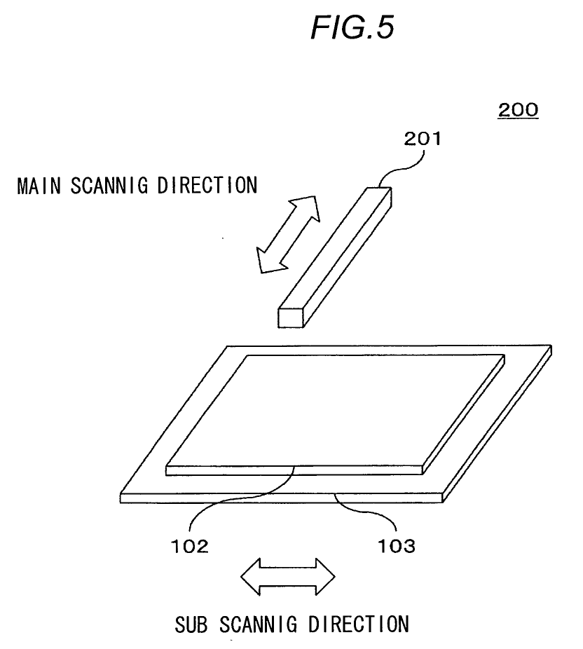

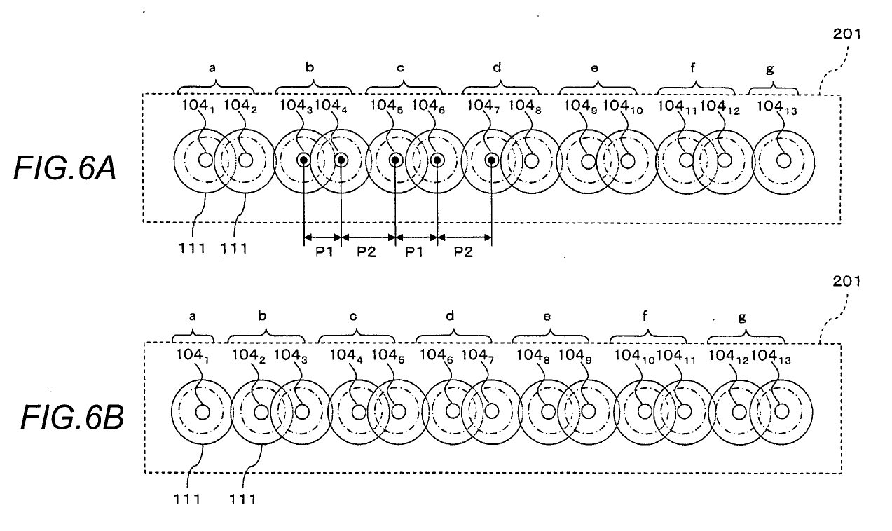

Next, a drawing apparatus according to exemplary embodiment 2 will be described with reference to FIGS. 5 and 6. It is noted that description of composing elements common to those of the drawing apparatus 100 of exemplary embodiment 1 is herein omitted or simplified by using like reference numerals to refer to such elements.

The drawing apparatus 200 includes, as shown in FIG. 5, an inkjet head 201 that discharges a plurality of liquid drops, a supporting table 103 that holds a substrate 102 and a moving member that moves the inkjet head 201 relatively to the substrate 102 held by the supporting table 103.

The inkjet head 201 is provided with nozzles 104 each of which intermittently discharges a prescribed amount of solution in the form of a liquid drop and which are in number of three or more and arranged in a main scanning direction. When such an inkjet head 201 is used, a prescribed area may be plotted along each scanning line of the substrate 102 without relatively moving in the main scanning direction.

In the drawing apparatus 200 having the aforementioned architecture, a pattern is drawn along a prescribed scanning line of the substrate 102 by alternately repeating relative movement of the inkjet head 201 in the main scanning direction and plotting of the prescribed scanning line. Subsequently, the inkjet head 201 is relatively moved in a sub scanning direction so as to similarly draw a pattern along an adjacent scanning line. In the case where the inkjet head 201 is a full-line head capable of drawing a pattern in the whole area of each scanning line of the substrate 102, the inkjet head 201 is not relatively moved in the main scanning direction but is relatively moved in the sub scanning direction alone.

Also in a drawing method of this embodiment, in the same manner as in the drawing method of exemplary embodiment 1, on the basis of linear image data including three or more dots, liquid drops 111 in the same number as the dots are used for drawing a linear pattern extending in the main scanning direction along a prescribed scanning line of the substrate 102. The plural liquid drops 111 are grouped into a plurality of groups that include at least a group composed of two or more adjacent liquid drops and each of which is composed of one, two or more liquid drops. In a group composed of two or more liquid drops, each liquid drop is allowed to hit on the substrate 102 so as to overlap an adjacent liquid drop 111 of the same group. Also, a liquid drop 111 disposed at an end of one group is allowed to hit on the substrate 102 so as to be spaced from an adjacent liquid drop 111 disposed at an end of an adjacent group and to be joined to the adjacent liquid drop 111 disposed at the end of the adjacent group when spread on the substrate 102.

In the drawing apparatus 100 of exemplary embodiment 1 described above, the aforementioned drawing method is practiced by controlling the relative movement of the inkjet head 101 in the main scanning direction or the discharging frequency of the liquid drops. On the contrary, in the drawing apparatus 200 of this embodiment, the inkjet head 201 is provided with a plurality of nozzles 104, so that the aforementioned drawing method may be practiced in accordance with the arrangement of the nozzles 104.

The plural nozzles 104 of the inkjet head 201 are grouped into a plurality of groups that include at least a group composed of two or more adjacent nozzles and each of which is composed of one, two or more nozzles. In a case shown in FIG. 6, the plural nozzles 104 are grouped into a plurality of groups each composed of one or two nozzles. In the case shown in FIG. 6A, assuming that one end (that is, the left end in the drawing) of the arrangement of the nozzles is a starting point and that n is an odd number, a nozzle 104ₙ and a nozzle 104ₙ₊₁ disposed in the nth and the (n+1)th positions in the arranging order together make up one group, and a nozzle 104ₙ₊₂ disposed in the (n+2)th position is grouped into a different group from the (n+1)th nozzle 104ₙ₊₁. Specifically, in the case shown in FIG. 6A, a first nozzle 104₁ and a second nozzle 104₂ together make up a group a, and a third nozzle 104₃ and a fourth nozzle 104₄ together make up a group b. The nozzles disposed thereafter are similarly grouped so as to make up groups c through f by two adjacent nozzles each. The final 13th nozzle 104₁₃ singly makes up a group g.

In the case shown in FIG. 6B, assuming that one end (that is, the left end in the drawing) of the arrangement of the nozzles is a starting point and that n is an even number (including zero), a nozzle 104ₙ and a nozzle 104ₙ₊₁ disposed in the nth and the (n+1)th positions in the arranging order together make up one group, and a nozzle 104ₙ₊₂ disposed in the (n+2)th position is grouped into a different group from the (n+1)th nozzle 104ₙ₊₁. Specifically, in the case shown in FIG. 6B, a first nozzle 104₁ singly makes up a group a. The nozzles disposed thereafter are grouped so as to make up groups b through f by two adjacent nozzles each.

The plural nozzles 104 thus grouped are arranged in the following manner: A pitch between two adjacent nozzles 104 in one group composed of two or more nozzles 104 is one that allows liquid drops 111 discharged from these nozzles 104 to hit on the substrate 102 to overlap each other, and a pitch between a nozzle 104 disposed at an end of one group and an adjacent nozzle 104 disposed at an end of an adjacent group is one that allows liquid drops 111 discharged from these nozzles 104 to hit on the substrate 102 to be spaced from each other and to be joined to each other when spread on the substrate 102.

For example, in the case shown in FIG. 6A, the nozzles 104 are arranged in the following manner: Assuming that n is an odd number, a pitch P1 between the nth nozzle 104ₙ and the (n+1)th nozzle 104ₙ₊₁ adjacent to each other in one group is a pitch that allows the liquid drops 111 discharged from these nozzles 104 to hit on the substrate 102 to overlap each other, and a pitch P2 between the (n+1)th nozzle 104ₙ₊₁ and the (n+2)th nozzle 104ₙ₊₂ adjacent to each other in different groups is a pitch that allows the liquid drops 111 discharged from these nozzles 104 to hit on the substrate 102 to be spaced from each other and to be joined to each other when spread on the substrate 102.

Furthermore, in the case shown in FIG. 6B, the nozzles 104 are arranged in the following manner: Assuming that n is an even number, a pitch P1 between the nth nozzle 104ₙ and the (n+1)th nozzle 104ₙ₊₁ adjacent to each other in one group is a pitch that allows the liquid drops 111 discharged from these nozzles 104 to hit on the substrate 102 to overlap each other, and a pitch P2 between the (n+1)th nozzle 104ₙ₊₁ and the (n+2)th nozzle 104ₙ₊₂ adjacent to each other in different groups is a pitch that allows the liquid drops 111 discharged from these nozzles 104 to hit on the substrate 102 to be spaced from each other and to be joined to each other when spread on the substrate 102.

When the plural nozzles 104 are arranged in the aforementioned manner, a pitch between two nozzles 104 adjacent to each other in one group composed of two or more nozzles 104 is smaller than a pitch between a nozzle 104 disposed at an end of one group and an adjacent nozzle 104 disposed at an end of an adjacent group.

When the inkjet head 201 having the aforementioned structure is used, liquid drops 111 discharged from the respective nozzles 104 included in one group composed of two or more nozzles are allowed to hit to overlap each other and become continuous to each other after hit. Also, a liquid drop 111 discharged from a nozzle 104 disposed at an end of one group is spread after the hit so as to be joined to a liquid drop discharged from an adjacent nozzle 104 disposed at an end of an adjacent group. Accordingly, all the liquid drops 111 become continuous to one another, so that a desired pattern extending in the main scanning direction may be drawn along the respective scanning lines of the substrate 102.

Since the liquid drops 111 discharged from the respective nozzles of each group composed of two or more nozzles are allowed to hit to overlap each other, a distance between the adjacent liquid drops is never too large, and therefore, the occurrence of jaggy may be suppressed. A liquid drop 111 discharged from a nozzle 104 disposed at an end of one group is spread after the hit to be joined to a liquid drop 111 discharged from an adjacent nozzle 104 disposed at an end of an adjacent group. Therefore, even when a bulge is caused in a group composed of two or more nozzles, a solution flows from the bulge to a joining portion between the groups, resulting in reducing or eliminating the bulge.

As described so far, according to the drawing method, the inkjet head 201 and the drawing apparatus 200 including the inkjet head 201 of this embodiment, the occurrence of jaggy and bulge is suppressed, resulting in drawing a pattern with a uniform width. As a result, a wiring pattern with a uniform pattern width may be formed on a printed wiring board, and pixels and/or a black matrix with a uniform pattern width may be formed on a color filter, and thus, the quality of the wiring board and the color filter may be improved.

A pitch P1 between two nozzles 104 adjacent to each other in one group may not more than the diameter D of each liquid drop 111 obtained before the hit. For example, in the case shown in FIG. 6A, a pitch between the nozzles 104₃ and 104₄ of the group b or a pitch between the nozzles 104₅ and 104₆ of the group c, namely, a pitch P1 between the nth nozzle 104ₙ and the (n+1)th nozzle 104ₙ₊₁, whereas n is assumed to be an odd number, may not more than the diameter D of each liquid drop 111 obtained before the hit. Thus, a liquid drop 111 may definitely overlap a priorly hit liquid drop 111 even before the priorly hit liquid drop 111 is spread on the substrate 102.

Furthermore, a pitch P2 between a nozzle 104 disposed at an end of one group and an adjacent nozzle 104 disposed at an end of an adjacent group may satisfy an equation (ii) described below, wherein the diameter of each liquid drop 111 obtained before the hit is D and a contact angle between the substrate 102 and the liquid drop 111 is 0. For example, in the case shown in FIG. 6A, a pitch between the nozzle 104₄ of the group b and the nozzle 104₅ of the group c or a pitch between the nozzle 104₆ of the group c and the nozzle 104₇ of the group d, namely, a pitch P2 between the (n+1)th nozzle 104ₙ₊₁ and the (n+2)th nozzle 104ₙ₊₂, whereas n is an odd number, may satisfy the following equation (ii):

$$\frac{D}{2 {\{ 8 tan \frac{θ}{2} ( 3 + {tan}^{2} \frac{θ}{2} ) \}}^{\frac{1}{3}}} + \frac{D}{2} < p 2 < \frac{D}{2 {\{ 8 tan \frac{θ}{2} ( 3 + {tan}^{2} \frac{θ}{2} ) \}}^{\frac{1}{3}}} \qquad ( ii )$$

Thus, no matter whether a priorly hit liquid drop 111 is spread on the substrate 102, a liquid drop 111 may be allowed to hit to be spaced from the priorly hit liquid drop 111 and may be spread after the hit so as to be joined to the priorly hit liquid drop 111.

It is noted that the present invention is not limited to the aforementioned embodiments but may be appropriately changed or modified. In addition, the shape, the dimension, the numerical value, the form, the number, the arrangement and the like of each element described in each embodiment are not particularly specified but arbitrarily set as far as the present invention is practiced.

1. A method for drawing a pattern extending in a direction on a target material by discharging three or more liquid drops by an inkjet method, comprising:
grouping the three or more liquid drops into a plurality of groups which include at least a group composed of two or more adjacent liquid drops and each of which is composed of one, or two or more liquid drops;
discharging each liquid drop included in the group composed of two or more liquid drops so that the adjacent liquid drop hits the target material to overlap each other; and
discharging a liquid drop at an end of each group so that the liquid drop hits the target material to be spaced from an adjacent liquid drop at an end of an adjacent group and the liquid drop is spread on the adjacent liquid drop disposed at the end of the adjacent group.

2. The method according to claim 1, wherein the plurality of liquid drops hit the target material successively along the pattern with one end of the pattern as a starting point.

3. A method for drawing a pattern extending in a direction on a target material by discharging three or more liquid drops by an inkjet method, comprising:
discharging the plurality of liquid drops to successively hit the target material along the pattern with one end of the pattern as a starting point,
wherein, when n is an odd number or an even number, an (n+1)th liquid drop hits the target material to overlap an area where an nth liquid drop has been hit and spread on the target material,
an (n+2)th liquid drop hits the target material not to overlap an area where the (n+1)th liquid drop has been hit and spread on the target material so that the (n+1)th liquid drop and the (n+2)th liquid drop spread and overlap each other.

4. The method according to claim 3, wherein a time elapsing between a hit of the nth liquid drop and a hit of the (n+1)th liquid drop is longer than a time elapsing between the hit of the (n+1)th liquid drop and a hit of the (n+2)th liquid drop.

5. The method according to claim 3, wherein a first pitch between a center of the nth liquid drop and a center of the (n+1)th liquid drop is less than a diameter of each liquid drop obtained before hit.

6. The method according to claim 3, the following equation (i) is satisfied:
$$\frac{D}{2 {\{ 8 tan \frac{θ}{2} ( 3 + {tan}^{2} \frac{θ}{2} ) \}}^{\frac{1}{3}}} + \frac{D}{2} < P 2 < \frac{D}{{\{ 8 tan \frac{θ}{2} ( 3 + {tan}^{2} \frac{θ}{2} ) \}}^{\frac{1}{3}}}$$
wherein p2 represents a second pitch between the (n+1)th liquid drop and the (n+2)th liquid drop,
D represents a diameter of each liquid drop obtained before hit, and
θ represents a contact angle between the target material and each liquid drop.

7. An inkjet head comprising:
three or more nozzles arranged in a direction so that each of the three or more nozzles discharging a liquid drop to draw a pattern extending,
wherein the plurality of nozzles are grouped into a plurality of groups that include at least a group composed of two or more adjacent nozzles and each of which is composed of one, or two or more nozzles,
two nozzles adjacent to each other in the group including two or more adjacent nozzle have such a pitch that liquid drops discharged from the two nozzles hit the target material to overlap each other, and
a nozzle disposed at an end of one group and an adjacent nozzle disposed at an end of an adjacent group have such a pitch that liquid drops discharged from the adjacent nozzles hit the target material to be spaced from each other so as to spread and overlap each other.

8. An inkjet head comprising:
three or more nozzles which are arranged in a direction for drawing of discharging a pattern extending in a direction on a target material by discharging a liquid drop from each nozzle,
wherein, when one end of arrangement of the plurality of nozzles is a starting point and n is an odd number or an even number, a first pitch between a center of an nth nozzle and a center of an (n+1)th nozzle is a pitch for discharging a liquid drop discharged from the (n+1)th nozzle to hit the target material to overlap an area where a liquid drop discharged from the nth nozzle has been hit and spread on the target material, and
a second pitch between a center of the (n+1)th nozzle and a center of an (n+2)th nozzle is a pitch for discharging a liquid drop discharged from the (n+2)th nozzle to hit the target material not to overlap an area where the liquid drop discharged from the (n+1)th nozzle has been hit and spread on the target material so that the liquid drop discharged from the (n+1)th nozzle and the liquid drop discharged from the (n+2)th nozzle are spread and overlapped each other.

9. The inkjet head according to claim 8,
wherein the first pitch is less than a diameter of each liquid drop obtained before hit.

10. The inkjet head according to claim 8, the following equation (ii) is satisfied,
$$\frac{D}{2 {\{ 8 tan \frac{θ}{2} ( 3 + {tan}^{2} \frac{θ}{2} ) \}}^{\frac{1}{3}}} + \frac{D}{2} < P 2 < \frac{D}{{\{ 8 tan \frac{θ}{2} ( 3 + {tan}^{2} \frac{θ}{2} ) \}}^{\frac{1}{3}}}$$
wherein p2 represents a second pitch between the (n+1)th liquid drop and the (n+2)th liquid drop,
D represents a diameter of each liquid drop obtained before hit, and
θ represents a contact angle between the target material and each liquid drop.

11. A drawing apparatus for drawing a pattern extending in a direction on a target material by discharging three or more liquid drops by an inkjet method, comprising:
an inkjet head which is discharges the plurality of liquid drops; and
a moving mechanism which moves the inkjet head relatively to the target material in the direction,
wherein three or more liquid drops are grouped into a plurality of groups that include at least a group composed of two or more adjacent liquid drops and each of which is composed of one, or two or more liquid drops, and
each liquid drop included in a group composed of two or more liquid drops is discharged to hit the target material to overlap an adjacent liquid drop of the same group, and a liquid drop at an end of one group hits the target material to be spaced from an adjacent liquid drop at an end of an adjacent group so that the liquid drop at an end of one group is spread and overlapped the adjacent liquid drop at the end of the adjacent group when spread on the target material.

12. The drawing apparatus according to claim 11, wherein the inkjet head is relatively moved while discharging the plurality of liquid drops along the pattern with one end of the pattern set as a starting point.

13. A drawing apparatus for drawing a pattern extending in a direction on a target material by discharging three or more liquid drops by an inkjet method, comprising:
an inkjet head which discharges the plurality of liquid drops; and
a moving mechanism which moves the inkjet head relatively to the target material in the direction,
wherein the inkjet heat is relatively moved while successively discharging the plurality of liquid drops along the pattern with one end of the pattern set as a starting point, and
when n is an odd number or an even number, an (n+1)th liquid drop hits the target material to overlap an area where an nth liquid drop has been hit and spread on the target material,
an (n+2)th liquid drop hits the target material not to overlap an area where the (n+1)th liquid drop has been hit and spread on the target material so that the (n+1)th liquid drop and the (n+2)th liquid drop are spread and overlapped each other when spread on the target material.

14. The drawing apparatus according to claim 13, wherein a time elapsing between a discharge of the nth liquid drop and a discharge of the (n+1)th liquid drop is longer than a time elapsing between the discharge of the (n+l )th liquid drop and a discharge of the (n+2)th liquid drop.

15. The drawing apparatus according to claim 13, wherein the moving mechanism relatively moves the inkjet head that a first pitch between the nth liquid drop and the (n+1)th liquid drop is less than a diameter of each liquid drop obtained before hit.

16. The drawing apparatus according to claim 13, wherein the moving mechanism relatively moves the inkjet head, and the following equation (i) is satisfied,
$$\frac{D}{2 {\{ 8 tan \frac{θ}{2} ( 3 + {tan}^{2} \frac{θ}{2} ) \}}^{\frac{1}{3}}} + \frac{D}{2} < p 2 < \frac{D}{{\{ 8 tan \frac{θ}{2} ( 3 + {tan}^{2} \frac{θ}{2} ) \}}^{\frac{1}{3}}}$$
wherein p2 represents a second pitch between the (n+1)th liquid drop and the (n+2)th liquid drop,
D represents a diameter of each liquid drop obtained before hit, and
θ represents a contact angle between the target material and each liquid drop.

17. A drawing apparatus comprising:
an inkjet head said inkjet head comprising:
three or more nozzles arranged in a direction so that each of the three or more nozzles discharging a liquid drop to draw a pattern extending,
wherein the plurality of nozzles are grouped into a plurality of groups that include at least a group composed of two or more adjacent nozzles and each of which is composed of one, or two or more nozzles,
two nozzles adjacent to each other in the group including two or more adjacent nozzles have such a pitch that liquid drops discharged from the two nozzles hit the target material to overlap each other, and
a nozzle disposed at an end of one group and an adjacent nozzle disposed at an end of an adjacent group have such a pitch that liquid drops discharged from the adjacent nozzles hit the target material to be spaced from each other so as to spread and overlan each other.

18. A method for manufacturing a printed wiring board on which a wiring pattern is included, comprising:
drawing a wiring pattern extending in a direction on a target material by discharging three or more liquid drops by an inkjet method, comprising:
grouping the three or more liquid drods into a plurality of groups which include at least a group composed of two or more adjacent liquid drops and each of which is composed of one, or two or more liquid drops;
discharging each liquid drop included in the group composed of two or more liquid drops so that the adjacent liquid drop hits the target material to overlap each other; and
discharging a liquid drop at an end of each group so that the liquid drop hits the target material to be sdaced from an adjacent liquid drop at an end of an adjacent group and the liquid drop is spread on the adjacent liquid drod disdosed at the end of the adjacent group.

19. A method for manufacturing a color filter on which a plurality of pixels and a black matrix partitioning the plurality of pixels are provided, comprising:
drawing at least one of the plurality of pixels and the black matrix by drawing a pattern extending in a direction on a target material by discharging three or more liquid drops by an inkjet method, comprising:
grouping the three or more liquid drops into a plurality of groups which include at least a group composed of two or more adjacent liquid drods and each of which is composed of one, or two or more liquid drops;
discharging each liquid drop included in the group composed of two or more liquid drops so that the adjacent liquid drop hits the target material to overlap each other; and
discharging a liquid drod at an end of each group so that the liquid drop hits the target material to be spaced from an adjacent liquid drop at an end of an adjacent group and the liquid drod is spread on the adjacent liquid drop disposed at the end of the adjacent group.
